(19) United States
(12) Patent Application Publication
(10) Pub. No.: US 2008/0101412 A1
(43) Pub. Date: May 1, 2008

(54) METHOD AND APPARATUS FOR GENERATING A MESSAGE IN A COMMUNICATION SYSTEM

(75) Inventors: Norbert Schwagmann, Braunschweig (DE); Holger Schmidt, Braunschweig (DE); Marco Hahn, Oldenburg (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/554,290

(22) Filed: Oct. 30, 2006

(51) Int. Cl. H04J 3/24

(52) U.S. Cl. 370/474; 370/389

(57) ABSTRACT

A method and apparatus for generating a message in a communication system, the method including inserting a first media identifier identifying a first media into the message, inserting a second media identifier identifying a second media into the message, inserting at least one communication service identifier identifying at least one communication service or at least one communication application identifier identifying at least one communication application into the message, and individually assigning each of the first media identifier and the second media identifier to at least one of the at least one communication service identifier or to at least one of the at least one communication application identifier.

### BACKGROUND OF THE INVENTION

The present invention relates to methods of generating a message in a communication system, a method of transmitting media, a communication device, and a computer program product.

The Internet Protocol Multimedia Subsystem (IMS) is an extension of the initially packet-oriented Core Network (e.g. GGSN, . . . ) in a mobile radio system in accordance with a Third Generation Partnership Project (3GPP) communication standard. The IMS is used for the signaling of any packet-switched communication service.

The so-called Session Initiation Protocol (SIP) is used as signaling protocol within IMS.

In order to determine, to which communication service a received SIP message refers to, it is conventional to insert a communication service specific code word into the header of the SIP message, a so-called service-feature-tag.

By way of example, in accordance with the communication service Push-to-Talk over Cellular (PoC) according to the Open Mobile Alliance (OMA) standard, the following header is inserted into the SIP message:

Accept-Contact: *; +g.poc.talkburst.

One disadvantage of this approach can be seen in that in accordance with this approach, the communication service identifier is defined on SIP communication session level. This means that all media which are defined/opened via the SIP communication session can only be commonly assigned to one communication service. Thus, it is not possible to assign one portion of media (e.g. one media data stream) to one communication service and another portion of media (e.g. another media data stream) to another communication service. Thus, the conventional approach does not provide any flexibility which is yet required if, for example, it is desired to start a plurality of communication services via one SIP communication session. This, however, is an option within IMS.

For these and other reasons there is a need for the present invention as will be described in more detail below.

### BRIEF DESCRIPTION OF THE DRAWINGS

FIG. 1 illustrates a communication system in accordance with one embodiment of the invention;

FIG. 2 illustrates the structure of a user equipment with respect to three functional levels “IMS protocol stack”, communication services and computer applications in accordance with one embodiment of the invention;

FIG. 3 illustrates a message flow diagram in accordance with one embodiment of the invention;

FIG. 4 illustrates a flow diagram showing the generation of an offer message and/or an answer message in accordance with one embodiment of the invention;

FIG. 5 illustrates a media description in accordance with the session description protocol in accordance with one embodiment of the invention;

FIG. 6 illustrates a media description in accordance with session description protocol in accordance with another embodiment of the invention;

FIG. 7 illustrates a media description in accordance with session description protocol in accordance with yet another embodiment of the invention;

FIG. 8 illustrates a media description in accordance with session description protocol in accordance with yet another embodiment of the invention; and

FIG. 9 illustrates a communication device in accordance with one embodiment of the invention.

For clarity, previously identified features retain their reference indicia in subsequent drawings, where appropriate.

### DETAILED DESCRIPTION OF THE INVENTION

The Internet Protocol Multimedia Subsystem (IP Multimedia Subsystem, IMS) is an extension of the initially packet-oriented Core Networks (e.g. GGSN, . . . ) in a mobile radio communication system, for example in a mobile radio communication system in accordance with the Third Generation Partnership Project (3GPP), e.g. UMTS, via which the signaling for any arbitrary packet-switched communication services (e.g. Internet Protocol-based communication services or Multimedia Services) is carried out.

IMS provides basic functionalities such as e.g. message routing, charging, quality of service (QoS), security, and so on, which are provided for any arbitrary packet-switched communication services.

The so-called Session Initiation Protocol is used as a signaling protocol within IMS. However, it should be mentioned that the invention is not limited to either SIP or IMS. Any other signaling protocol as well as any other suitable communication platform or framework that provides the desired communication functionalities may be used in alternative embodiments of the invention.

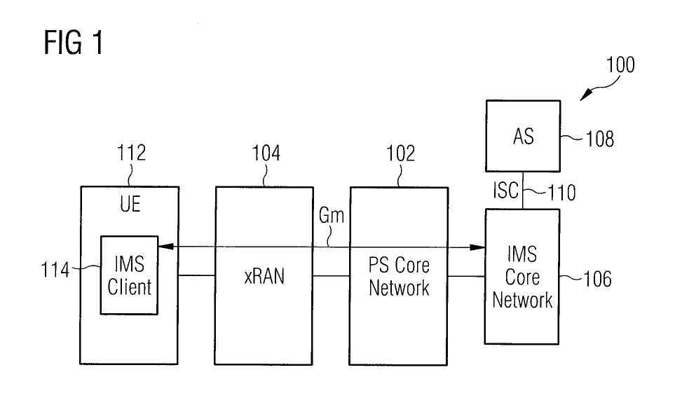

The individual components of a communication system 100 in accordance with an embodiment of the invention are shown in FIG. 1.

The communication system 100 includes a packet-switched Core Network 102, a mobile radio access network 104 connected to the packet-switched Core Network 102 and an IMS Core Network 106 being connected to the packet-switched Core Network 102. An application server (AS) 108 is connected to the IMS Core Network 106 via an internet service connection (ISC) 110. Furthermore, the communication system 100 includes one or a plurality (generally an arbitrary number) of user equipments (e.g. a communication terminal device) 112. In addition to conventional communication components which are provided in the user equipment 112 for providing mobile radio communication functionalities and which will not be described herein in more detail, in accordance with one embodiment of the invention, the user equipment 112 includes an IMS client 114, which will be described in more detail below. The IMS client 114 is configured to establishing an IMS connection Gm 116 to the IMS Core Network 106.

The basic procedures and components are in accordance with the IMS communication system with the extensions in accordance with the embodiments of the inventions as will be described in more detail below.

In the context of this description, a user equipment may be understood as being any kind of electronic device that is capable of communicating in the above and in the following described manner. By way of example, a user equipment may be understood as being any kind of communication device such as e.g. a wireless phone, a mobile radio terminal, a personal digital assistant, a laptop, a notebook, a personal computer, a wireless local area network device, etc. In one embodiment of the invention, the user equipments are UMTS user equipments.

The IMS may be understood as a signaling network that is defined and standardized in a general sense and which is not restricted to a specific communication service. If a communication service is defined and standardized, all functions and functional processes required thereof (e.g. between one user equipment and another user equipment or between a user equipment and a server) will be described. In order to implement these functional processes the IMS will be used, in other words, a communication service is based on IMS, or, if it was described on the basis of communication layers, the communication service is arranged above (in other words “is lying above”) the IMS.

Examples of a communication service are the Open Mobile Alliance (OMA) Push-to-Talk over Cellular (PoC) and Messaging.

A communication application may be understood in accordance with an embodiment of the invention to be a freely selectable, non-standardized computer program (which may be used e.g. in a computer device or in a mobile device such as a mobile radio device such as a mobile radio phone), which accesses or uses one or a plurality of the communication services. Thus, a communication application may be understood to be arranged in a communication layer arranged above the communication layer the communication services are implemented in.

In one embodiment of the invention, a game computer program, e.g. a chess computer program may be a communication application, in which a user can exchange the game sequences with the other user he is playing with, via the communication network (e.g. using the communication service “Messaging”). Furthermore, the user can verbally exchange himself with the other user (in other words, talk to the other user) (e.g. using the communication service “PoC”).

This means that communication applications can access a plurality of communication services and that a plurality of communication applications can access (also simultaneously) one specific communication service.

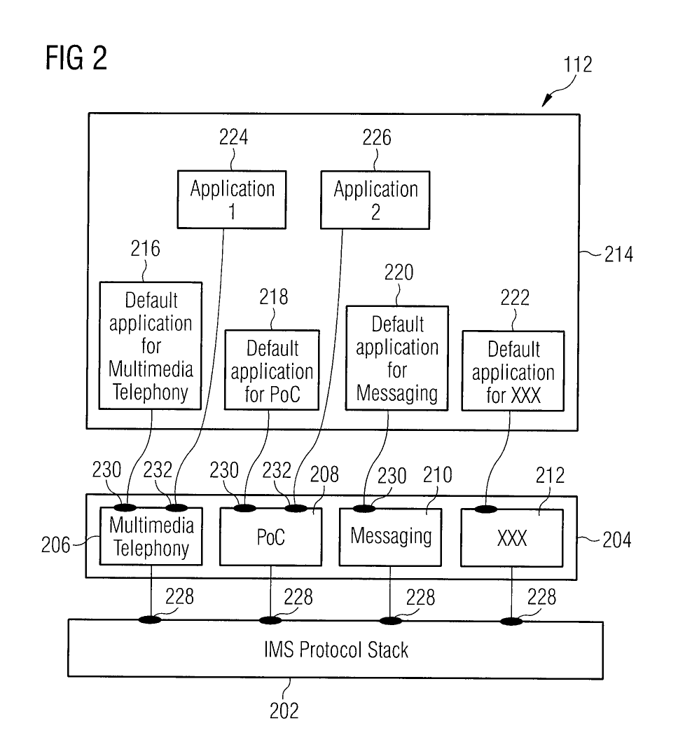

FIG. 2 shows the structure of the user equipment 112 with respect to the three functional levels (also may be referred to as layers) “IMS protocol stack”, communication services and computer applications in accordance with one embodiment of the invention, as will be described in more detail below.

In one embodiment of the invention, the user equipment 112 includes or has implemented an IMS protocol stack 202.

A plurality of communication services are provided in a communication service layer 204 arranged above the IMS protocol stack 202. The communication services use functions provided by the units of the IMS protocol stack 202.

In this exemplary embodiment, the following communication services are provided in the communication service layer 204, although in alternative embodiments of the invention, any other suitable communication service may be provided in addition or instead of the communication services described herein:

a multimedia telephony communication service provided by a correspondingly configured multimedia telephony communication service unit 206;

a Push-to-Talk over Cellular communication service provided by a correspondingly configured (e.g. in accordance with OMA) Push-to-Talk over Cellular communication service unit 208;

a Messaging communication service provided by a correspondingly configured (e.g. in accordance with OMA) Messaging communication service unit 210; and

any additional communication service provided by a correspondingly configured additional communication service unit 212.

In alternative embodiments of the invention, a file exchange service or media streaming service, e.g. an audio streaming service or a video streaming service, may be provided as a communication service.

A plurality of communication applications are provided in a communication application layer 214 arranged above the communication service layer 204. The communication applications use services provided by the units of the communication service layer 204. In other words, the communication applications use one or a plurality of communication services (one after the other or simultaneously) that are provided in the communication service layer 204.

In this exemplary embodiment, the following communication applications are provided in the communication application layer 214, although in alternative embodiments of the invention, any other suitable communication application may be provided in addition to or instead of the communication applications described herein:

a default communication application for multimedia telephony 216;

a default communication application for Push-to-Talk over Cellular 218;

a default communication application for Messaging 220;

a default communication application for an additional application 222;

a first user-defined communication application, e.g. a game computer program 224; and

a second user-defined communication application, e.g. a user-defined communication computer program 226.

Communication service identifiers 228 provide a framework for the identification of IMS communication services utilizing the so-called IMS enablers. An IMS communication service is provided via the use of the IMS enablers. At communication terminals (e.g. a user equipment), the use of a communication service identifier 228 is similar to the use of the port concept in accordance with the Transport Control Protocol/Internet Protocol (TCP/IP), in that it allows communication applications in a communication terminal and the communication network that use e.g. SIP for communication purposes to be identified. In the communication terminal this means dispatching a SIP message to the correct communication service, and in the communication network it means selection of the correct communication server via ISC 110. Examples of IMS based communication services are, as described above, OMA messaging and OMA PoC.

The communication service may be an aggregation of one or a plurality of media components (also referred to as media or media data streams in the following) and the service logic managing the aggregation, represented in the communication protocols used. Its behavior and characteristics may be standardized as has been done for the two examples described above, or proprietary and specific for e.g. an operator or an enterprise.

In one embodiment of the invention, a service description specifies this behavior and states e.g. the allowed media combinations and state transitions as a consequence of signaling and use of IMS enablers in the communication network and the communication terminals.

The need of applying a communication service identifier is to be taken within the specification of each individual service.

The communication service identifier identifies IMS communication services and shall be included in the relevant SIP methods, for example.

An IMS communication application may be understood as a communication application that uses one or a plurality of IMS communication service(s) in order to provide a specific service to the end-user. The IMS communication application uses a specific one or plurality of IMS communication service(s) and provides the end-user service through the re-use of the SIP communication part of service, for example. The IMS communication application does in one embodiment of the invention not extend the definition of the one or plurality of IMS communication service(s). IMS communication application identifiers 230 are provided for identifying the IMS communication application utilizing the one or plurality of IMS communication service(s). Furthermore, IMS communication application references 232 are provided that are used to identify those IMS communication applications other than the default IMS communication applications for the IMS communication service. The IMS communication application references 230, 232 have significance at the communication terminal and the SIP application server (AS) behaving as SIP endpoints. The means to transport the IMS communication application references 230, 232 is defined within the IMS communication services.

During the initialization of a communication connection between two users, i.e. between two communication terminals such as two user equipments, the media types and the formats of the media (in the following also referred to as media streams or as media data streams) to be used are negotiated between the two communication terminals. In one embodiment of the invention, the media may be understood as distinct portions of media that are transmitted during a running communication session (descriptively a discontinuous media data stream) or a continuous transmission of media data (descriptively a continuous media data stream).

In one embodiment of the invention, the media may be media selected from a group of media consisting of: speech media; audio media; video media; text media; still image media; graphical media (e.g., describing vector graphics); and multimedia comprising at least two of the above media.

In one embodiment of the invention, audio media may be provided as media for IP telephony on the one hand and audio media and video media may be provided as media for video streaming on the other hand.

In one embodiment of the invention, the negotiation of the media to be used may be carried out in accordance with the so-called “Offer-Answer” model of the Internet Engineering Task Force (IETF). In an alternative embodiment of the invention, however, any other desired communication protocol may be provided for the negotiation of the media to be used.

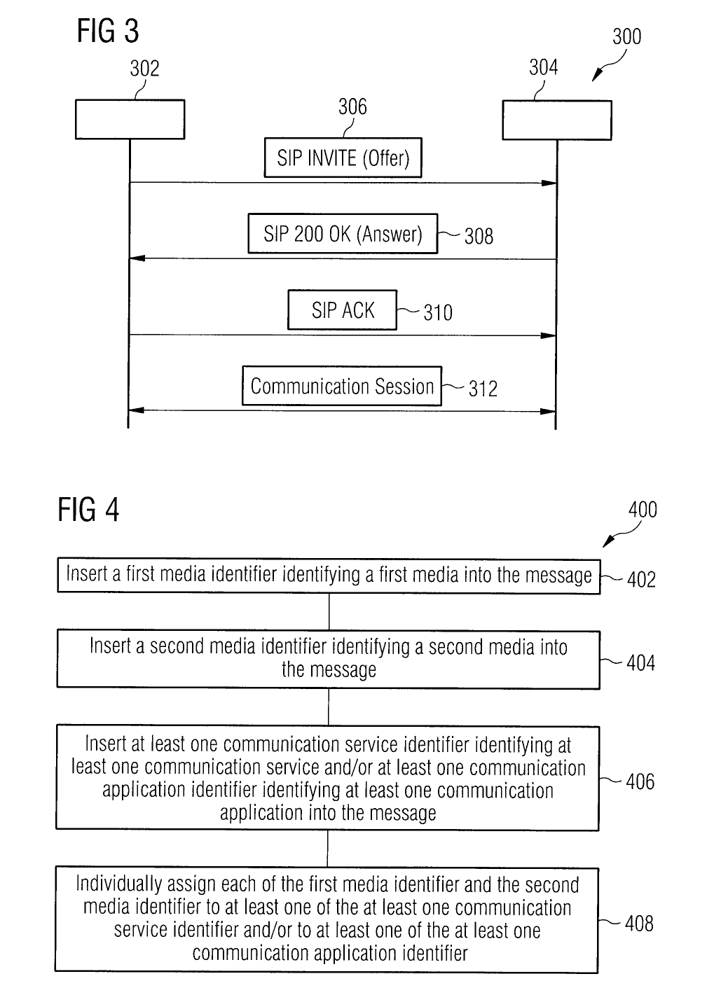

In one embodiment of the invention and in accordance with the “Offer-Answer” model, as illustrated in a message flow diagram 300 in FIG. 3, a first user equipment 302 is generating a SIP INVITE message 306 and transmits it to a second user equipment 304, the first user equipment 302 wants to establish a communication connection with. In general, using the INVITE request, i.e. the communication connection initialization using SIP, one of the participating parties (e.g. the first user equipment 302) transmits descriptions of the media formats that it supports to the other party (e.g. the second user equipment 304). This may be referred to as “Offer”.

In response to the receipt of the “Offer” (e.g. the SIP INVITE message 306), the other party (e.g. the second user equipment 304) generates an SIP 200 OK message 308 as an answer message and transmits it to the initiating party (e.g. the first user equipment 302). In general, the “Offer” receiving party (e.g. the second user equipment 304) responds with descriptions of the type of media and formats of media it supports and that have been offered to it by the initiating party (e.g. the first user equipment 302). This may be referred to as “Answer”.

In alternative embodiment of the invention, the generated message may be a session initiation protocol 200 OK message (in order to negotiate the media actually used during the communication session using the communication service and/or communication application), a session initiation protocol RE-INVITE message (in order to change the media used during an already established and running communication session using the communication service and/or communication application), or a session initiation protocol UPDATE message (in order to change the media used during an already established and running communication session using the communication service and/or communication application).

In one embodiment of the invention, the media descriptions are implemented by means of or in accordance with the Session Description Protocol (SDP).

In one embodiment of the invention, the answer message (e.g. the SIP 200 OK message 308) may include a plurality of possible types of media and formats of media the other party (e.g. the second user equipment 304) supports. In an alternative embodiment of the invention, the answer message (e.g. the SIP 200 OK message 308) may include only one format for each type of media to be used. In other words, in this embodiment of the invention, the answer message may already be reduced to respectively one format per media type. Besides, the answer message (e.g. the SIP 200 OK message 308) may include a rejection of the media types offered by the initiating party in the offer message (e.g. the SIP INVITE message 306).

During the setup of the communication session, there are several possibilities to exchange offer messages and answer messages in alternative embodiments of the invention. The number of possibilities will increase if specific SIP extensions are supported. This is true in IMS.

In one embodiment of the invention, in response to the receipt of the answer message (e.g. the SIP 200 OK message 308), the initiating party (e.g. the first user equipment 302) generates a confirmation message (e.g. a SIP ACK message 310) and transmits it to the other party (e.g. the second user equipment 304), thereby confirming receipt of the answer message (e.g. the SIP 200 OK message 308) to the other party (e.g. the second user equipment 304). Now, the communication session is set up for using the negotiated communication service(s) and/or communication application(s) using the respectively assigned media.

After having setup the communication connection or communication session, the media are transmitted in accordance with the above negotiated assignments within the corresponding communication service(s) and/or communication application(s) (in FIG. 3 symbolized as a communication session block 312).

In one embodiment of the invention, the offer message (e.g. the SIP INVITE message 306) and/or the answer message (e.g. the SIP 200 OK message 308) may be generated as illustrated in a flow diagram 400 in FIG. 4.

At 402, a first media identifier identifying a first media is inserted into the message.

At 404, a second media identifier identifying a second media is inserted into the message.

Furthermore, at 406, at least one communication service identifier identifying at least one communication service and/or at least one communication application identifier identifying at least one communication application is inserted into the message.

At 408, each of the first media identifier and the second media identifier is individually assigned to at least one of the at least one communication service identifier and/or to at least one of the at least one communication application identifier.

In one embodiment of the invention, the assignments of the media to the corresponding communication service and/or to the corresponding communication application are defined together with the media descriptions by means of SDP. In accordance with conventional SDP specification, in one embodiment of the invention, the assignments are defined by the offerer, i.e. the initializing party (e.g. the first user equipment 302).

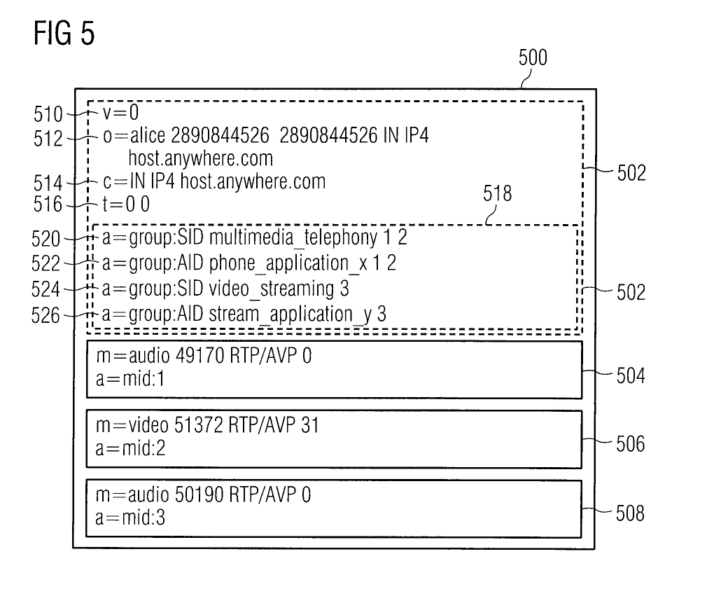

FIG. 5 illustrates a media description 500 in accordance with the SPD in the offer message (e.g. the SIP INVITE message 306) in accordance with one embodiment of the invention.

The media description 500 includes a Session Level section 502 and a plurality of three (generally an arbitrary number of) Media Level sections 504, 506, 508.

The Session Level section 502 includes communication session-wide parameters, in other words parameters which are valid for the entire communication session.

The Media Level sections 504, 506, 508 include parameters for individual media.

To begin with, a respective attribute row “a=mid:x” is used, wherein “mid” denotes a respective media identifier (media ID) and “x” then denotes the corresponding media identifier value. The different media are thus numbered and uniquely identified.

In the embodiment shown in FIG. 5, the first Media Level section 504 refers to a first media “m=audio 49170 RTP/AVP 0”, i.e. an audio media being transmitted using the Real-time Transport Protocol (RTP)/Audio Video Profile (AVP), the audio media being assigned the number 49170. The first media defined in the first Media Level section 504 is assigned with the media identifier value “1”.

The second Media Level section 506 refers to a second media “m=video 51372 RTP/AVP 31”, i.e. a video media being transmitted using the Real-time Transport Protocol (RTP)/Audio Video Profile (AVP), the audio media being assigned the number 51372. The second media defined in the second Media Level section 506 is assigned with the media identifier value “2”.

The third Media Level section 508 refers to a third media “m=audio 50190 RTP/AVP 0”, i.e. an audio media being transmitted using the Real-time Transport Protocol (RTP)/Audio Video Profile (AVP), the audio media being assigned the number 50190. The third media defined in the third Media Level section 508 is assigned with the media identifier value “3”.

In the embodiment shown in FIG. 5, the media are then assigned to the communication services and the communication applications on the communication session level, i.e. in the Session Level section 502 of the media description 500. This is implemented as well using attribute rows.

The Session Level section 502 of the media description 500 includes a version row 510 (“v=0”), in this embodiment of the invention designating that SDP version 0 is used.

The Session Level section 502 of the media description 500 further includes an owner and session identifier row 512 including the name of the session initiator, two communication session identifiers, the net- and address-type and the address of the machine from which the session was created (in this embodiment: “o=alice 2890844526 2890844526 IN IP4 host.anywhere.com”).

The Session Level section 502 of the media description 500 further includes a connection information row 514 including the network type, the address type and the connection address (in this embodiment: “c=IN IP4 host.anywhere.com”).

Furthermore, the Session Level section 502 of the media description 500 includes a time field “t=0 0” 516.

The Session Level section 502 of the media description 500 further includes an assignment section 518, which includes the respective assignments of the media to the respective communication services and/or communication applications.

In the embodiment shown in FIG. 5, the assignment section 518 includes four assignment rows 520, 522, 524, and 526, which have the following structure:

a first assignment row 520 includes an assignment of the first media and the second media to a communication service having the communication service identifier SID “multimedia_telephony” (a=group:SID multimedia_telephony 1 2);

a second assignment row 522 includes an assignment of the first media and the second media to a communication application having the communication application identifier AID “phone application_x” (a=group:AID phone_application_x 1 2);

a third assignment row 524 includes an assignment of the third media to a communication service having the communication service identifier SID “video_streaming” (a=group:SID video_streaming 3); and

a fourth assignment row 526 includes an assignment of the third media to a communication application having the communication application identifier AID “stream_application_y” (a=group:AID stream_application_y 3).

In other words, in the first attribute row 520 of the assignment section 518, e.g. the communication service (in this case determined by means of the communication service identifier SID) that is relevant for this SIP INVITE message, is determined (in this case “multimedia_telephony”). Using the media ID values, the corresponding associated media are assigned to the communication service (in this case media ID values 1 and 2). The second attribute row 522 of the assignment section 518 defines the associated communication application (AID) (in this case “phone_application_x), which is associated with the same media (in this case media ID values 1 and 2). The third attribute row 524 and the fourth attribute row 526 are formed in a corresponding manner, respectively.

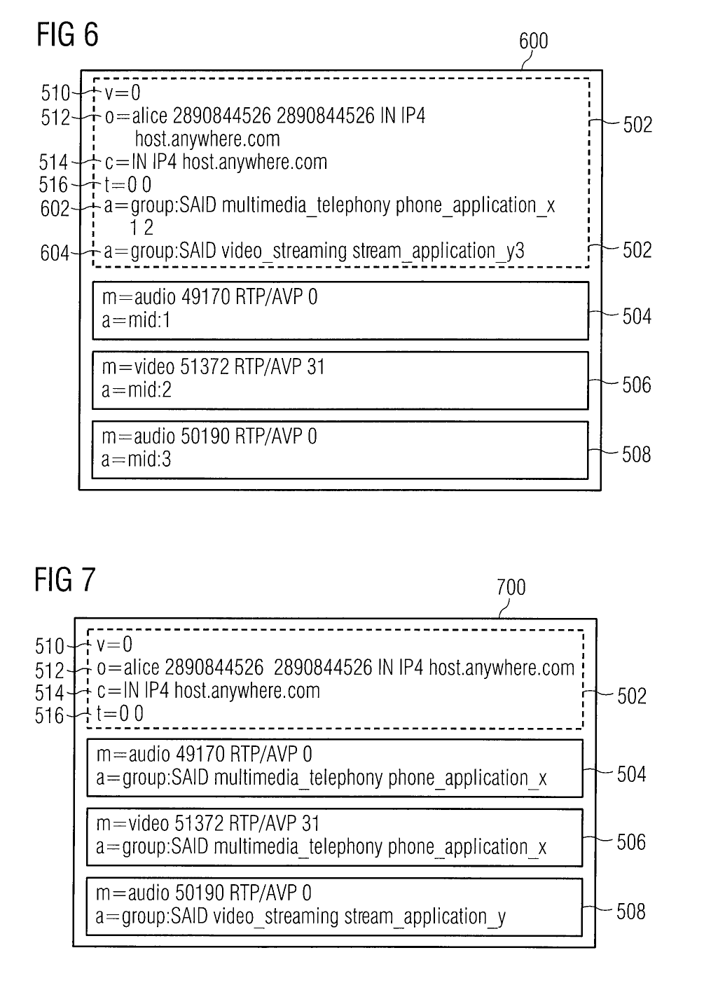

FIG. 6 illustrates a media description 600 in accordance with the SPD in the offer message (e.g. the SIP INVITE message 306) in accordance with another embodiment of the invention.

The media description 600 shown in FIG. 6 is similar to the media description 500 shown in FIG. 5 with the difference that the assignments to a communication service and a communication application are combined in one attribute row. In detail, a first attribute row 602 includes the information of the first attribute row 520 and the second attribute row 522 of the assignment section 518 of the media description 500 shown in FIG. 5 (in this case “a=group:SAID multimedia_telephony phone_application_x 1 2”). A second attribute row 604 includes the information of the third attribute row 524 and the fourth attribute row 526 of the assignment section 518 of the media description 500 shown in FIG. 5 (in this case “a=group:SAID video_streaming stream_application_y 3”). “SAID” denotes the communication service and communication application identifier.

In this embodiment, there is provided a fixed order such that at first, the communication service identifier is listed and then the communication application identifier.

FIG. 7 illustrates a media description 700 in accordance with the SPD in the offer message (e.g. the SIP INVITE message 306) in accordance with yet another embodiment of the invention.

The media description 700 shown in FIG. 7 is similar to the media description 500 shown in FIG. 5 with the difference that the assignments to a communication service and a communication application are directly provided in the respective Media Level sections 504, 506, 508. In this embodiment of the invention, it is not even necessary to amend the Session Level section 502 of the media description 500.

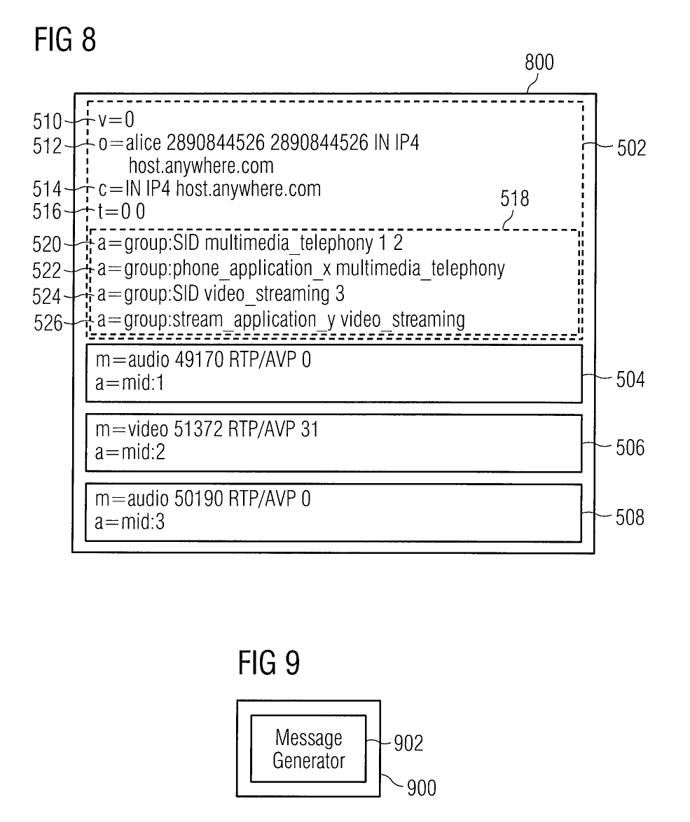

FIG. 8 illustrates a media description 800 in accordance with the SPD in the offer message (e.g. the SIP INVITE message 306) in accordance with yet another embodiment of the invention.

The media description 800 shown in FIG. 8 is similar to the media description 500 shown in FIG. 5 with the difference that the media are only directly assigned to the communication services. The communication services are assigned to the communication applications (thus, the media are not directly but rather indirectly assigned to the communication applications in this case).

FIG. 9 shows a communication device 900 in accordance with one embodiment of the invention. In addition to the conventional components of a communication device, e.g. of a mobile radio communication device, which will not be described in detail in this description, the communication device 900 includes a message generator 902 that is configured to insert a first media identifier identifying a first media into the message, to insert a second media identifier identifying a second media into the message, to insert at least one communication service identifier identifying at least one communication service or at least one communication application identifier identifying at least one communication application into the message, and to individually assigning the first media identifier and the second media identifier to the at least one communication service identifier or to the at least one communication application identifier.

The above mentioned units and processes can be implemented in hardware, e.g. by means of one or a plurality of specific electronic circuits, in software, e.g. by means of one or a plurality of correspondingly configured computer programs, or in any hybrid form, i.e. in any portions partly in hardware and partly in software.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method of generating a message in a communication system, the method comprising:
inserting a first media identifier identifying a first media into the message;
inserting a second media identifier identifying a second media into the message;
inserting at least one communication service identifier identifying at least one communication service or at least one communication application identifier identifying at least one communication application into the message; and
individually assigning each of the first media identifier and the second media identifier to at least one of the at least one communication service identifier or to at least one of the at least one communication application identifier.

2. The method of claim 1, wherein the message is a communication signaling message.

3. The method of claim 2, wherein the communication signaling message is a communication session setup signaling message

4. The method of claim 1, wherein the message is an internet based message.

5. The method of claim 4, wherein the internet based message is a session initiation protocol message.

6. The method of claim 5, wherein the session initiation protocol message is selected from a group of session initiation protocol messages consisting of: a session initiation protocol INVITE message, a session initiation protocol 200 OK message, a session initiation protocol RE-INVITE message, and a session initiation protocol UPDATE message.

7. The method of claim 1, wherein the first media and the second media are media selected from a group of media consisting of: speech media, audio media, video media, text media, still image media, graphical media, and multimedia comprising at least two of the above media.

8. The method of claim 1, wherein at least some of the first media identifier, the second media identifier, the at least one communication service identifier and the at least one communication application identifier are encoded in accordance with a Session Description Protocol structure.

9. The method of claim 8, wherein the Session Description Protocol structure comprises:
at least one Session Level section comprising parameters being valid for an entire communication session; and
at least one Media Level section comprising parameters for individual media.

10. The method of claim 9,
wherein the first media identifier and the second media identifier are inserted into the at least one Media Level section; and
wherein the assignments of the first media identifier and the second media identifier to the at least one communication service identifier or to the at least one communication application identifier are inserted into the at least one Session Level section.

11. The method of claim 9,
wherein the first media identifier and the second media identifier are inserted into the at least one Media Level section; and
wherein the assignments of the first media identifier and the second media identifier to the at least one communication service identifier or to the at least one communication application identifier are inserted into the at least one Media Level section.

12. The method of claim 1, further comprising:
inserting at least one communication service identifier identifying at least one communication service and at least one communication application identifier identifying at least one communication application into the message; and
individually assigning each of the first media identifier and the second media identifier to at least one of the at least one communication service identifier and to at least one of the at least one communication application identifier.

13. A method of generating a message in a communication system, the method comprising:
inserting a first media identifier identifying a first media into the message;
inserting a second media identifier identifying a second media into the message;
inserting at least one communication service identifier identifying at least one communication service and at least one communication application identifier identifying at least one communication application into the message;
individually assigning each of the first media identifier and the second media identifier to at least one of the at least one communication service identifier; and
individually assigning the at least one communication service identifier to at least one of the at least one communication application identifier.

14. The method of claim 13, wherein the message is a communication signaling message.

15. The method of claim 14, wherein the communication signaling message is a communication session setup signaling message.

16. The method of claim 13, wherein the message is an internet based message.

17. The method of claim 16, wherein the internet based message is a session initiation protocol message.

18. The method of claim 17, wherein the session initiation protocol message is selected from a group of session initiation protocol messages consisting of: a session initiation protocol INVITE message, a session initiation protocol 200 OK message, a session initiation protocol RE-INVITE message, and a session initiation protocol UPDATE message.

19. The method of claim 13, wherein the first media and the second media are media selected from a group of media consisting of: speech media, audio media, video media, text media, still image media, graphical media, and multimedia comprising at least two of the above media.

20. A communication device, comprising a message generator configured to
insert a first media identifier identifying a first media into the message;
insert a second media identifier identifying a second media into the message;
insert at least one communication service identifier identifying at least one communication service or at least one communication application identifier identifying at least one communication application into the message; and
individually assign each of the first media identifier and the second media identifier to at least one of the at least one communication service identifier or to at least one of the at least one communication application identifier.

21. A computer program product for generating a message in a communication system, the computer program product comprising:
instruction code to insert a first media identifier identifying a first media into the message;
instruction code to insert a second media identifier identifying a second media into the message;
instruction code to insert at least one communication service identifier identifying at least one communication service or at least one communication application identifier identifying at least one communication application into the message; and
instruction code to individually assign each of the first media identifier and the second media identifier to at least one of the at least one communication service identifier or to at least one of the at least one communication application identifier.

22. The computer program product of claim 21, wherein the message is a communication signaling message.

23. The computer program product of claim 22, wherein the communication signaling message is a communication session setup signaling message

24. The computer program product of claim 21, wherein the message is an internet based message.

25. The computer program product of claim 24, wherein the internet based message is a session initiation protocol message.

26. The computer program product of claim 25, wherein the session initiation protocol message is selected from a group of session initiation protocol messages consisting of: a session initiation protocol INVITE message, a session initiation protocol 200 OK message, a session initiation protocol RE-INVITE message, and a session initiation protocol UPDATE message.

27. The computer program product of claim 21, wherein the first media and the second media are media selected from a group of media consisting of: speech media, audio media, video media, text media, still image media, graphical media, and multimedia comprising at least two of the above media.

28. A method of transmitting media in a communication session, comprising:
setting up a communication session, the setting up comprising:
generating a message in a communication system by
inserting a first media identifier identifying a first media into the message;
inserting a second media identifier identifying a second media into the message;
inserting at least one communication service identifier identifying at least one communication service or at least one communication application identifier identifying at least one communication application into the message; and
individually assigning each of the first media identifier and the second media identifier to at least one of the at least one communication service identifier or at least one of to the at least one communication application identifier; and
transmitting the first media and the second media in accordance with the assignments within the at least one communication service or within the at least one communication application.

29. A system for generating a message in a communication system, the system comprising:
means for inserting a first media identifier identifying a first media into the message;
means for inserting a second media identifier identifying a second media into the message;
means for inserting at least one communication service identifier identifying at least one communication service or at least one communication application identifier identifying at least one communication application into the message; and
means for individually assigning each of the first media identifier and the second media identifier to at least one of the at least one communication service identifier or to at least one of the at least one communication application identifier.

30. A system for transmitting media in a communication session, comprising:
means for setting up a communication session, comprising:
means for generating a message in a communication system by
inserting a first media identifier identifying a first media into the message;
inserting a second media identifier identifying a second media into the message;
inserting at least one communication service identifier identifying at least one communication service or at least one communication application identifier identifying at least one communication application into the message; and
individually assigning each of the first media identifier and the second media identifier to at least one of the at least one communication service identifier or at least one of to the at least one communication application identifier; and
means for transmitting the first media and the second media in accordance with the assignments within the at least one communication service or within the at least one communication application.
